(19) United States
(12) Patent Application Publication
(10) Pub. No.: US 2011/0226143 A1
(43) Pub. Date: Sep. 22, 2011

(54) SINGLE STENCIL PATCHWORK SYSTEM

(76) Inventor: Michael Cudworth, Danville, CA (US)

(21) Appl. No.: 12/728,314

(22) Filed: Mar. 22, 2010

(51) Int. Cl. B05C 17/06; B41M 1/12

(52) U.S. Cl. 101/127; 101/129

(57) ABSTRACT

A stencil for applying indicia to a substrate, such as a lawn. The stencil is in the form of a flexible membrane having a plurality of openings for releaseably seeming the flexible membrane to the substrate or lawn. The flexible membrane is provided with a plurality of image regions corresponding to the indicia to be applied to the substrate or lawn. Each image legion has a bridging segment connecting the image region to the flexible membrane, the bridging segment being in the form of a flexible hinge to enable the image region to selectively cover and to selectively expose the substrate or lawn through the flexible membrane by selectively folding the image regions onto the substrate and onto the flexible membrane.

### TECHNICAL FIELD

The present invention is directed to a unique stencil used to apply an image to a substrate, such as a lawn. Unlike prior stencils, in practicing the present invention, a complex multipart image can be applied through the use of a single flexible member obviating the need to register one stencil on top of another to facilitate selective masking of a substrate or lawn during the image creation process.

### BACKGROUND OF THE INVENTION

As it is commonplace to apply indicia, such as images, on a substrate such as a lawn, there have been a plethora of suggested techniques to do so. Industrially, and in a commercial environment, complex machinery can be used to achieve the desired results. However, for non-commercial (domestic) applications, stencils are oftentimes the preferred method of image creation

It is quite common for those wishing to make a statement to do so on, for example, the front lawns of their homes. Such statements need not be political or in any way controversial, but could be as simple as an expression of support for a school or its sports team. Others might follow professional sports organizations and wish to express their affiliations, particularly, if a big game or event is imminent. In doing so, the average homeowner does not have access to professional image creating devices or the skilled labor necessary to operate them and thus must rely upon less costly, more user friendly alternatives.

One such alternative is the application of a stencil to a lawn by securing the four corners of the stencil in an area where the image is to be created. If a simple, one color image is to be applied, such a stencil having open regions can be used. In doing so, the stencil is first staked to the ground in the appropriate location and paint is sprayed or otherwise applied to the open regions resulting in the appropriate image being visible once the stencil has been removed.

In instances in which the image to be applied is more complex requiring contrasting colors in different image areas, the application of stencils of the prior art becomes a more complex and costly undertaking. The prior art suggests that in such instances, multiple stencils ate employed for selectively exposing and covering various image areas as pigments are selectively applied. Not only does this increase costs, but multiple stencils must be precisely aligned with one another to create the appropriate image registration. Complexities involved in such an undertaking are not surprising, for most stencils are created from flexible membranes that can be stretched from their at-rest states and if one stencil is stretched more than another, improper color and image registration will result. As such, oftentimes, images produced by the non-professional in a domestic environment lack the desired results.

It is thus an object of the present invention to provide a stencil capable of creating complex multicolored images on a substrate, such as a lawn, through the use of a single flexible membrane.

These and other objects will be more readily apparent when considering the following disclosure and appended claims.

### SUMMARY OF THE INVENTION

A stencil for applying indicia to a substrate, such as a lawn. The stencil is in the form of a flexible membrane having a plurality of openings for releaseably securing by way of staples or stakes the flexible membrane to the substrate or lawn. The flexible membrane is provided with a plurality of image regions corresponding to the indicia to be applied to the substrate or lawn. Each image region has a bridging segment connecting the image region to the flexible membrane, the bridging segment being in the form of a flexible hinge to enable the image region to selectively cover and to selectively expose the substrate or lawn through the flexible membrane by selectively folding the image regions onto the substrate and onto the flexible membrane.

### BRIEF DESCRIPTION OF THE FIGURES

FIGS. 1A-C are plan views of stencils produced according to the present invention residing on a substrate, such as a lawn.

FIG. 2 is a plan view of a more complex stencil produced according to the present invention residing on a substrate such as a lawn.

FIGS. 3A through 3E represent a sequence of steps for applying an image to such a substrate through the use of the stencil of FIG. 2.

FIG. 4 is a plan view of an image on a substrate, such as a lawn produced in carrying out the sequential steps of FIGS. 3A through 3E.

FIG. 5 is a plan view of another embodiment of the stencil of the present invention.

FIG. 6 depicts a plan view of three stencils connected to one another suggested for ensuring proper registration between images.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments in the invention are illustrated by way of example. It is to be expressly understood, however, that the drawings are for the illustration description only and are not intended as definitions of the limits of the invention The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

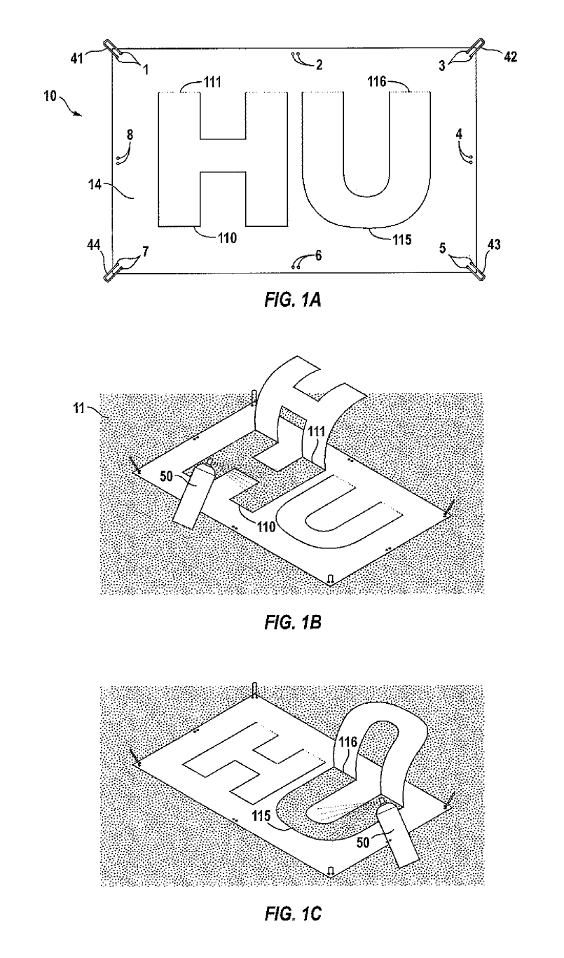

Turning first to FIG. 1, stencil 10 is shown including flexible membrane 14 placed atop lawn 11. As a preferred embodiment, flexible membrane 14 is shown to be generally rectangular having staple openings 1, 3, 5 and 7 proximate its four corners with optional staple openings 2, 4, 6 and 8 midpoint of said corners to enable a user to further secure stencil 10 to lawn 11 as required. Staples 41-44 can be placed through openings 1, 3, 5 and 7 and additional staples placed at the midpoint openings as desired. Lawn staples can also be placed elsewhere within the stencil as needed for stability and image conformity.

FIG. 1 represents the present invention in its simplist iteration. It is noted that stencil 10 is intended to apply the letters “H” and “U” perhaps indicative of Harvard University as being the affiliated entity to be messaged.

Once selectable membrane 14 has been applied to lawn 11, the “H” portion is selectively peeled back as shown in FIG. 1B noting that cut out border 110 extends about and defines the “H” with border region 111 remaining intact and not cut to provide a living hinge for the reasons more specifically recited hereinafter. Thus, the “H” is first peeled back as shown in FIG. 1B and pigment applied by generic spray can 50 employed to create this letter upon lawn 11. After doing so, the “H” is returned to its original orientation upon lawn 11 by folding it back upon living hinge 111 and, as noted in FIG. 1C, the process is repeated for the “U”. In doing so, it is important to note that when spraying the “U” image upon lawn 11, the pigment applied to create the “H” has been masked and thus will not be affected by the later applied “U” pigment without the need for any second stencil or elaborate masking system.

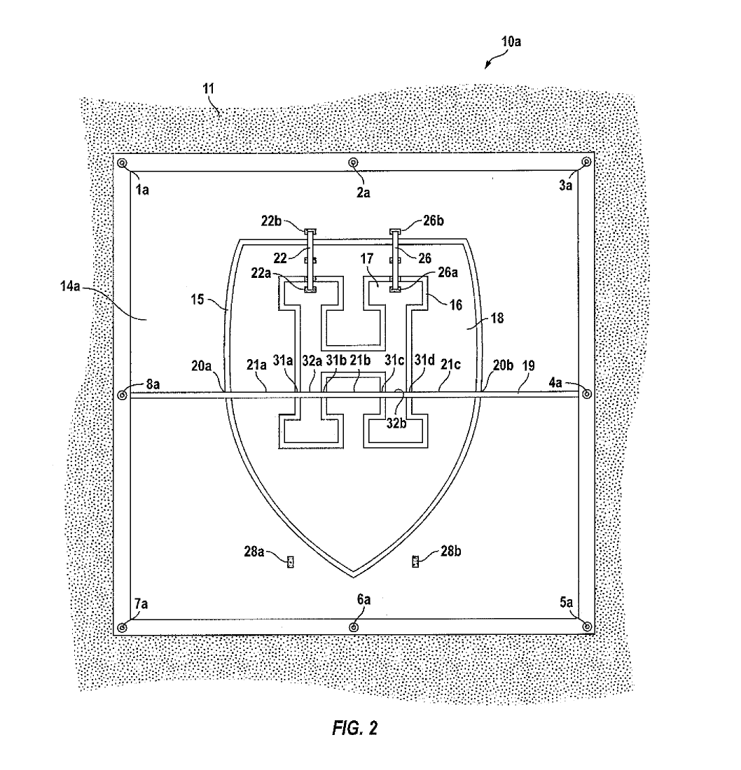

Further preferred embodiments of the present invention can be realized by reference to FIG. 2.

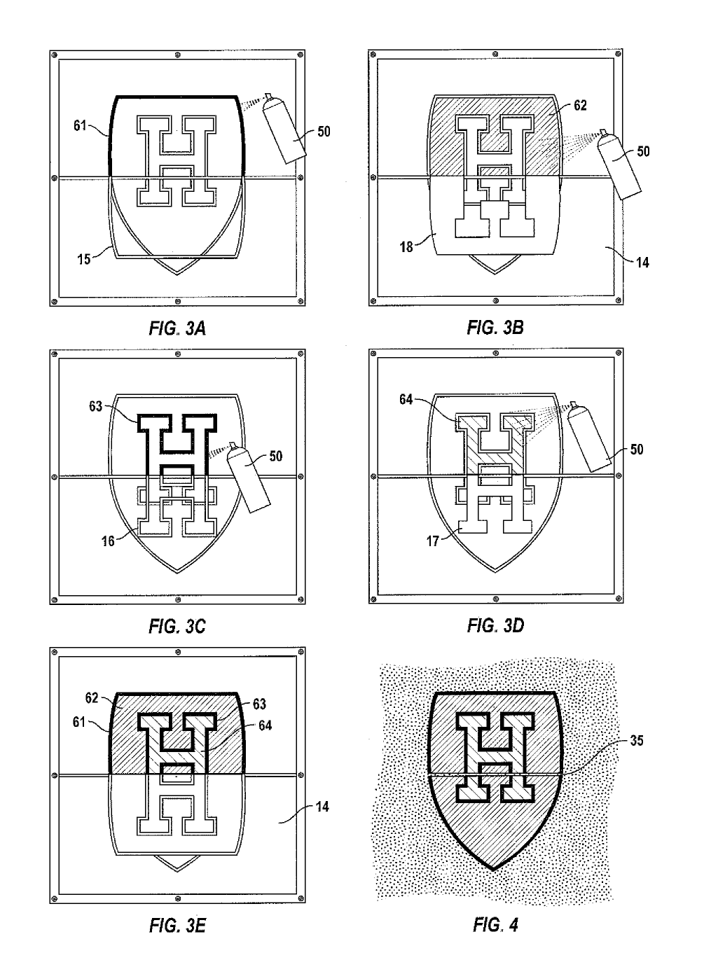

In reference to FIG. 2, a more complex image is depicted together with certain preferred embodiments which enhance the utility of the present invention. These will be more readily appreciated in going through the image creation sequence of FIGS. 3A through 3E.

As a first step (FIG. 3A), image region 15 corresponding to the upper boundary of the shield area of the image is created by cutting image region 15 from flexible membrane 14 except for areas 20a and 20b creating a flap of image legion 15 capable of folding from the top half of flexible membrane 14 and away from its image area on lawn 11 to the bottom half of flexible membrane 14. In other words, elements 20a and 20b create flexible hinges in order to enable image 15 to fold as shown in FIG. 2A. Once done, pigment is applied to flexible membrane 14 noting that only the image area below image region 15 receives pigment generically shown through the use of spray can 50.

In turning to FIG. 3B, image region 15 is then folded back from it lying against flexible membrane 14 as in FIG. 2A and atop image 61 thus masking image 61 from the application of further pigment.. Thereupon, image region 18 is folded away from lawn 11 along flexible hinge sections 21a, 21b and 21c upon the lower half of flexible membrane 14 thus exposing lawn 11 as depicted. Pigment is applied as shown generically by spray can 50 noting that all areas but those now exposed through the folding of image region 18 are masked, including previously applied image 61. Image portion 62 has now been applied which is then covered to mask it from the addition of other portions of the image by folding image region 18 from being folded against flexible membrane 14 back over indicia 62 by rotating it along bridging segments or flexible hinges 21a, 21b and 21C

Turning to FIG. 3C, it is noted that image regions 15 and 18 have been folded back to reside upon lawn 11 after pigment has been applied creating image areas 61 and 62. Thereupon, image region 16 is folded along flexible hinge sections 31a, 31b, 31c and 31d enabling pigment to be applied to lawn 11 creating the outline of the upper portion of the “H” 63 as depicted. Image region 16 is then folded back upon pigmented area 63 enabling one to then move on to the next step in the process shown in FIG. 3D.

Turning to FIG. 3D, it is shown that image region 17 is folded away from the substrate and onto flexible membrane 14 by folding image region 17 along flexible hinges 32a and 32b. Spray can 50 then applies pigment to the exposed area whereupon image region 17 is folded back covering newly applied image 64.

The upper portion of the image is completed as depicted in FIG. 3E. Thus, image areas 61, 62, 63 and 64 have now been applied through the use of a single flexible membrane 14 without the need for complex masking or multiple stencil registration. The entire image is shown completed in FIG. 4 noting that, in doing so, the lower portion of the image is folded back, step by step employing the identical flexible hinges as were used to create the upper most portion of the image. Upon doing so, strip 35 can be filled in if desired as a final step. In more complex designs, as a preferred embodiment the flaps can be coded with colors or with numbers to indicate the sequence in which the flaps are to be folded to add to the image. For example, in referring to FIGS. 3A and 3B, border 15 can be labeled with a number or color and flap 18 with a contrasting color or number in sequence to inform a user to fold back 15 before 18.

In comparing FIGS. 1 and 2, it is apparent that there are certain construction elements that are embodied in FIG. 2 that are not necessary in the more simplistic stencil of FIG. 1. Specifically, to add structural rigidity to stencil 14 and to thus minimize distortion of an image when the flexible membrane is applied onto a substrate, such as a lawn, optional stabilizing strip 19 can be employed. Stabilizing strip 19 can optionally comprise a thickened strip or one which is reinforced as compared to the body of flexible membrane 14 to, again, cause the flexible membrane to resist distortion when staked upon a suitable substrate. Stabilizing strip 19 could be something as simple as multiple layers of membrane material or could comprise a strip of plastic or metal as desired. Thus, when stabilizing strip 19 is applied, the various image regions sequentially folded from the substrate is subsequently applied thereto rotate around flexible hinges which are created with the positioning of stabilizing strip 19 in mind.

Although a single stabilizing strip 19 was depicted in FIG. 2 as a single horizontally extending element for simplicity, it should be realized that a number of stabilizing strips could be employed extending horizontally, vertically or diagonally with respect to the boundary of flexible membrane 14, the number of the stabilizing strips and their location being dictated by the complexity and overall design of the image to be applied.

To further resist image deformation, temporary securing strips 22 and 26 are shown. These strips, generally rectangularly shaped, secure image regions through the use of any appropriate fasteners such as, for example, hook and loop fastener pair 22a/22b and 26a/26b, such as portions of image region 17 to flexible member 14 and being spaced apart from bridging segments such as segments 32a and 32b. Continuing with this example, when image region 17 is folded back to expose the substrate area beneath that image region, temporary securing strips 22 and 26 are released by, for example, separating hook and loop fasteners 25b and 26b and reapplying these hook and loop fasteners to corresponding hook and loop fasteners 28a and 28b to maintain the folded orientation of this image region such as shown in FIG. 2D. Other temporary security strips can also be employed to ensure the integrity of images, particularly in using complex patterns.

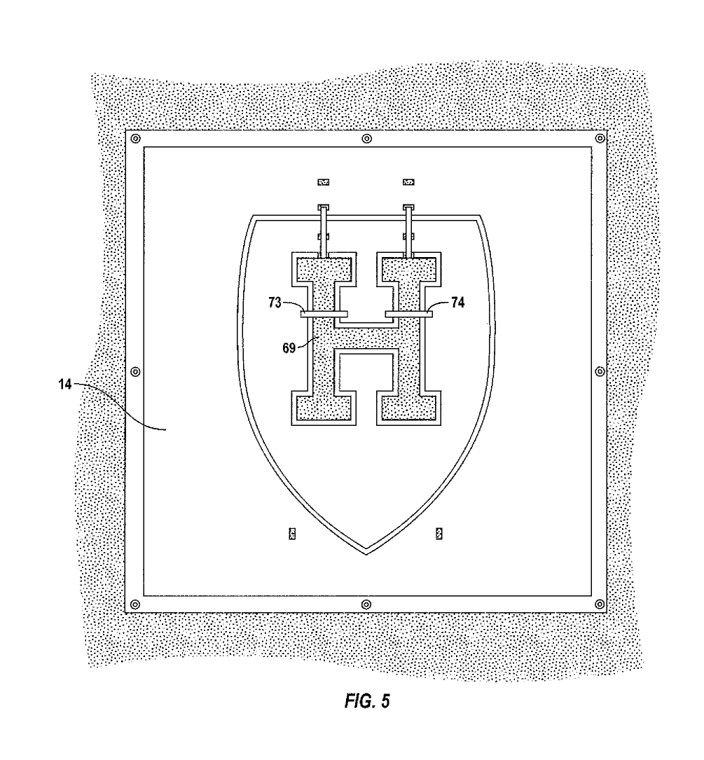

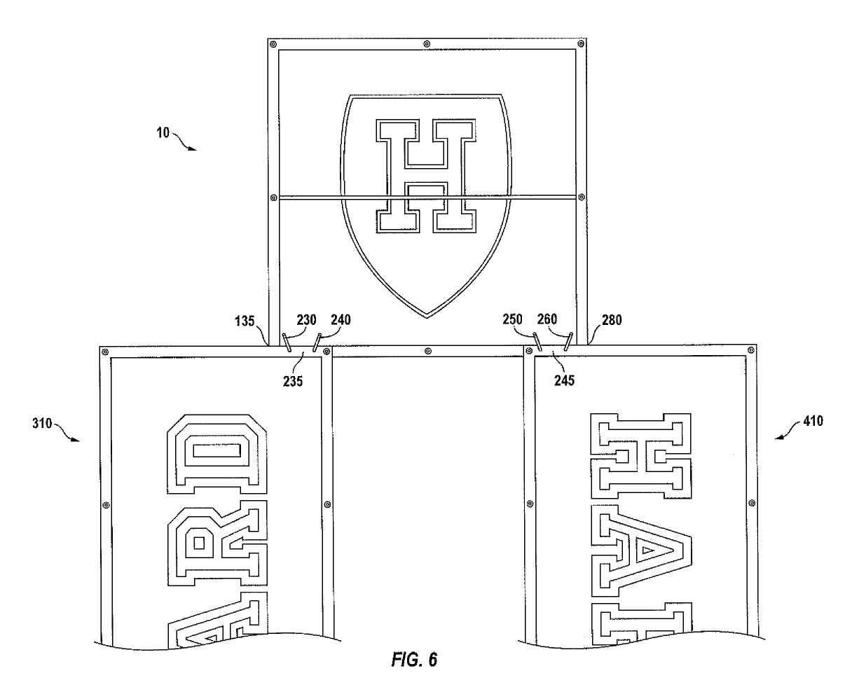

In turning to FIG. 5, the stencil of FIG. 2 is generally replicated but, however, in this instance, permanent securing strips are employed. It was found that if a stencil was to be used with large open cut out regions such as region 69, that to help prevent image deformation when flexible membrane 14 is staked to an appropriate substrate, such as a lawn, that permanent securing strips can be employed for bridging one or more of these open regions. The use of permanent seeming strips 73 and 74 are also shown, in this instance, bridging the membrane surrounding image area 69 insuring the image integrity of flexible membrane 14.

There are also instances in which a plurality of stencils are deemed appropriate in order to create the appropriate image onto a substrate. This would be particularly advantageous in creating larger images of any size where available. Stencil material or cutting machines present practical limitations which limit the production of oversized stencil membranes. In this regard, reference is made to FIG. 6 in which stencil 10 is joined with stencils 310 and 410. In doing so, registration is maintained between the three stencils as shown. Specifically, stencils 10, 310 and 410 are shown to be substantially rectangular. Corner 135 of stencil 10 is caused to substantially overlap with corner 235 of stencil 310 while corner 280 of stencil 10 is caused to overlap with corner 245 of stencil 410. To maintain registration, spikes 230, 240, 250 and 260 are passed through these membranes as shown. Thus, multiple flexible membranes can be releaseably joined for enhancing and expanding the utility of the present concept.

The above disclosure is sufficient to enable one of ordinary skill in the art to practice the invention, and provides the best of mode practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable, without departing from the true spirit and scope of the invention. Such changes might involve alternative materials, components, structural arrangements, sizes, shapes, forms, functions, operational features or the like.

What is claimed is:

1. A stencil for applying indicia to a substrate, said stencil comprising a flexible membrane having a plurality of openings for releaseably seeming said flexible membrane to said substrate, said flexible membrane having a plurality of image legions corresponding to the indicia to be applied to said substrate, each image region having a bridging segment connecting said image regions to said flexible membrane, said bridging segment comprising a flexible hinge to enable said image region to selectively cover and to selectively expose said substrate through said flexible membrane by selectively folding said image regions onto said substrate and onto said flexible membrane.

2. The stencil of claim 1 further comprising at least one open region in said flexible membrane for applying indicia to said substrate.

3. The stencil of claim 1 further comprising temporary securing strips releaseably connecting said image regions to said flexible membrane in an area spaced from said bridging segment.

4. The stencil of claim 3 wherein said temporary securing strips comprise generally rectangular elements having attachment fields to said image region and to said flexible membrane.

5. The stencil of claim 4 wherein said attachment fields comprise hook and loop fasteners/

6. The stencil of claim 3 wherein said temporary securing strips further are positioned to releaseably secure said image regions to said flexible membrane when said image regions are folded back to expose said substrate.

7. The stencil of claim 1 further comprising at least one stabilizing strip in the form of a strip of increased rigidity as compared to said flexible membrane.

8. The stencil of claim 2 further comprising at least one permanent securing strip bridging said at least one open region.

9. The stencil of claim 8 wherein said permanent securing strip comprises a generally rectangular strip having ends which are connected to said flexible membrane on opposite sides of said open region.

10. The stencil of claim 1 wherein said flexible membrane is substantially rectangular having four corners, each of said plurality of openings being located proximate each of said corners.

11. The stencil of claim 1 wherein certain image regions are coded to inform a user of a suggested sequence of steps to follow to apply said indicia to said substrate.

12. A method of applying an image to an area of lawn comprising laying a stencil on said lawn, said stencil comprising a flexible membrane having a plurality of openings for releaseably securing said flexible membrane to said lawn, said flexible membrane having a plurality of image regions corresponding to the indicia to be applied to said lawn, each image region having a bridging segment connecting said image region to said flexible membrane, said bridging segment comprising a flexible hinge to enable said image region to substantially cover and selectively expose said lawn through said flexible membrane by selectively folding said image region onto said lawn and onto said flexible membrane, folding image regions corresponding to a first portion of said image onto said flexible membrane along said flexible hinges to expose said lawn in said first portion and applying a first colorant thereto followed by, folding said image legions corresponding to said first portion along said hinge for covering said first colorant, folding image regions corresponding to a second portion of said image onto said flexible membrane along said hinges to expose said lawn in said second portion and applying a second colorant thereto followed by folding said image regions corresponding to said second portion o said image along said hinge for covering said second portion.

13. The method of claim 12 whereby said method is repeated by folding image regions along hinges to expose selective image areas of said lawn, applying a colorant in said selective image areas following by folding said image regions along hinges to cover said selected image areas until the entire of said image is applied to said lawn.

14. The method of claim 12 wherein said stencil further comprises temporary securing strips releaseably connecting said image regions to said flexible member such that said temporary securing strips are released from said flexible member to enable image regions to be folded along said hinges to reside atop said flexible member for exposing portions of said lawn.

15. The method of claim 14 wherein said temporary securing strips are attached to said flexible membrane to secure said image regions atop said flexible membrane for exposing portions of said lawn.

16. The method of claim 12 wherein said flexible membrane is substantially rectangular having four corners, each of said plurality of openings being located proximate each of said corners, said flexible membrane being releaseably fixed to said area of lawn by passing lawn staples or spikes though said openings.

17. The method of claim 16 further comprising the application of an additional stencil in the form of a flexible membrane being substantially rectangular having four corners wherein said flexible membranes are applied to said area of lawn by overlapping one corner of one flexible membrane with one corner of the other flexible membrane followed by applying spikes through both flexible membranes where the flexible membranes overlap one another.
